(19) United States
(12) Patent Application Publication
(10) Pub. No.: US 2026/0204848 A1
(43) Pub. Date: Jul. 16, 2026

(54) Portable multifunctional socket

(71) Applicant: Honglin Electric Power Technology (Thailand) Co., Ltd., Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd., Rayong (TH)

(21) Appl. No.: 19/023,726

(22) Filed: Jan. 16, 2025

(51) Int. Cl. H01R 13/72; H01R 13/66; H01R 27/02

(52) U.S. Cl. CPC H01R 13/72; H01R 13/6675; H01R 27/02

(57) ABSTRACT

The present invention relates to the field of electric energy transmission technology, and in particular to a portable multifunctional socket, comprising a bottom shell and a front shell, wherein the bottom shell and the front shell are arranged in coordination, the front shell can be fixed to the bottom shell by bolts, and the front shell is provided with jacks, USB ports and type-c ports for plug insertion; a power supply mechanism is installed in the bottom shell and the front shell, allowing plugs to be inserted into the power supply mechanism through the jacks, the USB ports and the type-c ports for electricity use, and the power supply mechanism is connected with a cable extending outside the bottom shell and the front shell, and an insertion head is fixedly connected to an end portion of the cable away from the power supply mechanism.

### TECHNICAL FIELD

The present invention relates to the field of electric energy transmission technology, and in particular to a portable multifunctional socket.

### BACKGROUND TECHNOLOGY

Sockets are a commonly used electrical appliance, which mainly play the role of power transmission. When in use, plugs of sockets are connected to the AC power, and then plugs of the electrical devices are plugged into the sockets. The use of the sockets greatly facilitates the power supply of electrical devices, thereby facilitating people's lives.

Existing sockets are commonly used in homes or offices. Although they are widely used and reliable, they are not convenient to carry, especially for studying, business trips or traveling. On the one hand, users may only need to add one or two sockets, and on the other hand, they also want to charge their mobile phones or iPads through the sockets, but they do not want the long power cord to affect the carrying. Therefore, a multifunctional socket that is easy to carry is needed to solve the above problems.

### SUMMARY OF THE INVENTION

The purpose of the embodiments of the present invention is to provide a portable multifunctional socket, aiming to solve the following problem: the power cord of the existing socket is too long and inconvenient to carry.

Embodiments of the present invention are implemented as follows: a portable multifunctional socket, comprising a bottom shell and a front shell, wherein the bottom shell and the front shell are arranged in coordination, the front shell can be fixed to the bottom shell by bolts, and the front shell is provided with jacks, USB ports and type-c ports for plug insertion; and a power supply mechanism is installed in the bottom shell and the front shell, allowing plugs to be inserted into the power supply mechanism through the jacks, wherein the USB ports and the type-c ports for electricity use, and the power supply mechanism is connected with a cable extending outside the bottom shell and the front shell, and an insertion head is fixedly connected to an end portion of the cable away from the power supply mechanism.

Preferably, the power supply mechanism comprises: a first circuit board, which is installed in the bottom shell and connected to the cable, wherein the first circuit board is connected to a copper sheet installed in the bottom shell, and a plug can be inserted into the copper sheet through the jacks to supply power; and a second circuit board, which is connected to the copper sheet, wherein USB power supply blocks and type-c power supply blocks aligned with the USB ports and the type-c ports are installed on the second circuit board.

Preferably, outside the bottom shell is provided a first wire groove, the front shell is provided with a second wire groove, the cable can be inserted into the first wire groove and the second wire groove, and one side of the second wire groove is provided with a slot for clamping the insertion head.

The portable multifunctional socket provided by the present invention can not only supply power, but also store cables, so as to facilitate the carrying of the socket, meet the demand of charging a mobile phone or an iPad through the socket, and is easy to use and highly practical.

### BRIEF DESCRIPTION OF THE DRAWINGS

FIG. 1 is a schematic diagram showing appearance of a portable multifunctional socket.

FIG. 2 is a schematic diagram showing the interior of the portable multifunctional socket.

FIG. 3 is a schematic diagram of a bottom shell of the portable multifunctional socket.

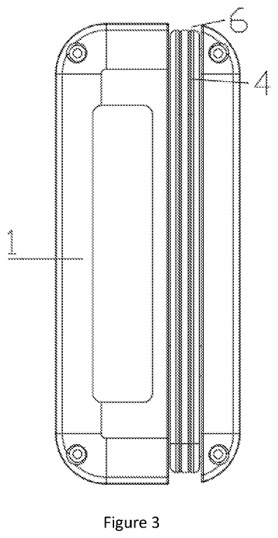

The markups in the drawings are indicated as follows:
1—bottom shell;
2—front shell;
3—power supply mechanism;
4—cable;
5—insertion head;
31—first circuit board;
32—copper sheet;
33—second circuit board;
34—USB power supply block;
35—type-c power supply block;
6—first wire groove;
7—second wire groove; and
8—slot.

### SPECIFIC EMBODIMENTS

In order to make the purpose, technical solutions and advantages of the present invention more clear, the present invention is further described in detail in conjunction with the accompanying drawings and embodiments. It should be understood that the specific embodiments described herein are only used to explain the present invention and do not limit the present invention.

The specific implementation of the present invention is described in detail in conjunction with the specific embodiments.

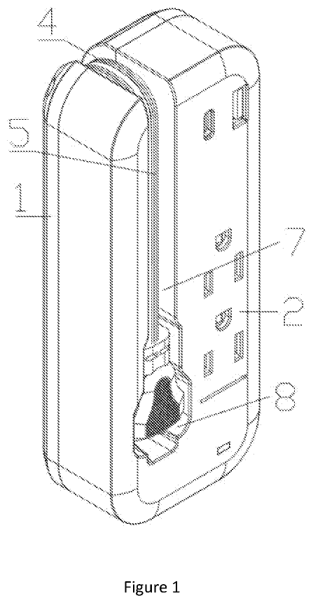

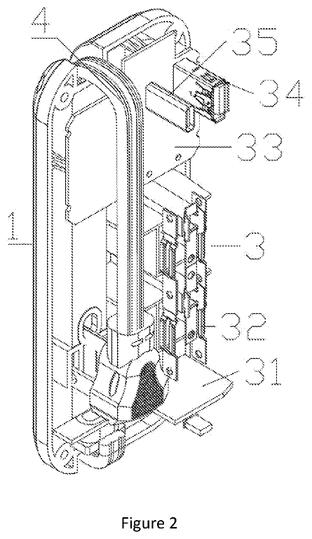

Please refer to FIGS. 1-2, an embodiment of the present invention provides a portable multifunctional socket, comprising:
a bottom shell 1 and a front shell 2, wherein the bottom shell 1 and the front shell 2 are arranged in coordination, the front shell 2 can be fixed to the bottom shell 1 by bolts, and the front shell 2 is provided with jacks, USB ports and type-c ports for plug insertion; and a power supply mechanism 3 installed in the bottom shell and the front shell, allowing plugs to be inserted into the power supply mechanism 3 through the jacks, the USB ports and the type-c ports for electricity use, wherein the power supply mechanism 3 is connected with a cable 4 extending outside the bottom shell 1 and the front shell 2, and an insertion head 5 is fixedly connected to an end portion of the cable 4 away from the power supply mechanism 3.

When the portable multifunctional socket is used, first unfold the cable 4 and insert the insertion head 5 into an AC socket, and then insert electrical devices, USB devices or type-c devices into the power supply mechanism 3 through the jacks, the USB ports and the type-c ports, so that the power supply mechanism 3 can then supply power to the electrical devices, USB devices or type-c devices.

As shown in FIG. 2, in a preferable embodiment of the present invention, the power supply mechanism 3 comprises: a first circuit board 31, which is installed in the bottom shell 1 and connected to the cable 4, wherein the first circuit board 31 is connected to a copper sheet 32 installed in the bottom shell 1, and a plug can be inserted into the copper sheet 32 through the jacks to supply power; and a second circuit board 33, which is connected to the copper sheet 32, wherein USB power supply blocks 34 and type-c power supply blocks 35 aligned with the USB ports and the type-c ports are installed on the second circuit board 33.

When electrical devices, USB devices or type-c devices are inserted into the jacks, the USB ports and the type-c ports, the electrical devices, USB devices or type-c devices can be respectively inserted into the copper sheet 32, USB power supply blocks 34 and type-c power supply blocks 35, thereby powering the electrical devices, USB devices or type-c devices.

As shown in FIG. 1 and FIG. 2, in a preferable embodiment of the present invention, outside the bottom shell 1 is provided a first wire groove 6, the front shell 2 is provided with a second wire groove 7, the cable 4 can be inserted into the first wire groove 6 and the second wire groove 7, and one side of the second wire groove 7 is provided with a slot 8 for clamping the insertion head 5.

The cable 4 can be inserted into the first wire groove 6 and the second wire groove 7 for storage, and the insertion head 5 can be inserted into the slot 8 for storage, which solves the pain points that traditional sockets are large in size and the cable 4 is inconvenient to carry and store. When the present invention is not in use, the cable 4 and the insertion head 5 can be fastened through the reserved first wire groove 6, the second wire groove 7 and the slot 8, which is more convenient to use and has a rounded appearance design. After the cable 4 and the insertion head 5 are fixed through the reserved first wire groove 6, the second wire groove 7 and the slot 8, they will not scratch other objects in the travel bag/school bag/hanging bag.

The above descriptions are only a preferred embodiment of the present invention and are not intended to limit the present invention. Any modifications, equivalent substitutions and improvements made within the spirit and principles of the present invention should be included in the protection scope of the present invention.

1. A portable multifunctional socket, comprising a bottom shell and a front shell, wherein the bottom shell and the front shell are arranged in coordination, the front shell can be fixed to the bottom shell by bolts, and the front shell is provided with jacks, USB ports and type-c ports for plug insertion; and
a power supply mechanism installed in the bottom shell and the front shell, allowing plugs to be inserted into the power supply mechanism through the jacks, wherein the USB ports and the type-c ports for electricity use, and the power supply mechanism is connected with a cable extending outside the bottom shell and the front shell, and an insertion head is fixedly connected to an end portion of the cable away from the power supply mechanism.

2. The portable multifunctional socket according to claim 1, wherein the power supply mechanism comprises:
a first circuit board, which is installed in the bottom shell and connected to the cable, wherein the first circuit board is connected to a copper sheet installed in the bottom shell, and a plug can be inserted into the copper sheet through the jacks to supply power; and
a second circuit board, which is connected to the copper sheet, where USB power supply blocks and type-c power supply blocks aligned with the USB ports and the type-c ports are installed on the second circuit board.

3. The portable multifunctional socket according to claim 1, wherein outside the bottom shell is provided a first wire groove, the front shell is provided with a second wire groove, the cable can be inserted into the first wire groove and the second wire groove, and one side of the second wire groove is provided with a slot for clamping the insertion head.
